(19) United States
(12) Patent Application Publication
(10) Pub. No.: US 2023/0264297 A1
(43) Pub. Date: Aug. 24, 2023

(54) METHOD FOR INTRODUCING OPENINGS INTO A DECORATIVE MATERIAL LAMINATED ONTO A CARRIER

(71) Applicant: Eissmann Automotive Deutschland GmbH, Bad Urach (DE)

(72) Inventors: Dirk BUCHLAUB, Münsingen (DE); Markus HELLDÖRFER, Troy, MI (US); Ludwig FLEINER, San Pedro Cholula, Puebla (MX)

(21) Appl. No.: 18/007,091

(22) PCT Filed: Jun. 25, 2021
(86) PCT No.: PCT/EP2021/067531

§ 371 Date: Jan. 27, 2023

(30) Foreign Application Priority Data
Jul. 29, 2020 (DE) 10 2020 120 032.3

(51) Int. Cl. B23K 26/38; B23K 26/03; B23K 37/04; B32B 3/26; B32B 37/12; B32B 7/12; B32B 38/04; B32B 38/18

(52) U.S. Cl. CPC B23K 26/38; B23K 26/032; B23K 37/0426; B32B 3/266; B32B 7/12; B32B 37/1207; B32B 38/04; B32B 38/1833; B23K 2103/34

(57) ABSTRACT

A method for introducing openings into a decorative material laminated onto a carrier comprises the following steps: providing a fixing device with at least two indicator pins and at least one absorption chamber, providing a carrier with holes for receiving the indicator pins and a decorative material with holes for receiving the indicator pins, pushing the carrier onto the indicator pins and then pushing the decorative material onto the indicator pins. The indicator pins extend through the holes in the carrier and the decorative material and visible parts of the indicator pins protrude above the decorative material, and the decorative material is positioned on the carrier and laminated onto the carrier. Openings are introduced into the decorative material above the openings in the carrier by means of a laser, by detecting the positions of the indicator pins and the heights of the visible parts of the indicator pins.

The present invention relates to a method for introducing openings into a decorative material which is laminated onto a carrier.

In automotive interior fittings, carriers which are usually three-dimensionally shaped, such as instrument panels, airbag covers, door decorative parts, etc., are usually laminated with decorative materials such as leather, artificial leather, fabric, etc. for a pleasing appearance.

Emblems or logos are often also fastened to the carriers, as is the case, for example, with steering wheel covers which are arranged centrally in the steering wheel. For this purpose, the emblems often have latching lugs which are pushed through into corresponding openings in the carrier and latch there.

In order to be able to subsequently provide a carrier laminated with a decorative material with openings, an opening must also be introduced into the decorative material at the location corresponding to the opening in the carrier.

It has hitherto been known to introduce corresponding openings into the decorative material by means of a metallic punch and then to laminate the punched decorative material onto the carrier, so that the openings in the carrier and the decorative material correspond.

However, this method is not advantageous for introducing small openings into decorative materials, since small openings cannot be punched with exact contours and the decorative material can also be partially stretched and corrugated by the punching. In addition, fraying can occur, which leads to an inhomogeneous structural image, or even a punching break can occur.

There is therefore a need to specify a method by means of which a laminated carrier with even small openings passing through the decorative material and the carrier can be produced with an exact fit and in a simple manner.

This object is achieved by the features of claim 1.

In the method according to the invention, a fixing device with at least two indicator pins and at least one absorption chamber is provided, a carrier with holes (indicator pin holes) for receiving the indicator pins and openings, and a decorative material which also has holes (indicator pin holes) for receiving the indicator pins. The carrier is first pushed onto the indicator pins of the fixing device and then the decorative material, wherein the indicator pins extend through the holes in the carrier and the decorative material and visible parts of the indicator pins protrude above the decorative material. The decorative material is positioned on the carrier and then laminated onto the carrier, then openings are introduced into the decorative material above the carrier openings by means of the laser. The positioning and lamination of the decorative material onto the carrier and the introduction of the openings into the decorative material by means of the laser are effected by detecting the position of the indicator pins and the heights of the visible parts of the indicator pins. Absorption chambers for absorbing the laser radiation are located below the openings in the carrier in the fixing device.

The method according to the invention is based, on the one hand, on the measurement/observation of the height of the visible part of each indicator pin in order to check whether the decorative material at the locations of the indicator pins is completely supported and laminated on the carrier everywhere and, on the other hand, on the measurement/observation of the positions of the indicator pins in order to determine the location at which the opening is to be produced into the decorative material by means of the laser, namely above the opening in the carrier. In addition, the depth of the laser drilling can also be observed via the height of the visible part of the indicator pins and the position of the indicator pin.

Since the indicator pins are longer than the layer thickness of the carrier and of the decorative material at the location of the indicator pin, the upper part of the indicator pins protrudes upwards from the visible side of the decorative material, and the position of the decorative material and the position of the carrier and its openings in the vicinity of the indicator pins can be precisely determined from the positions of the indicator pins and from the height of the parts of the indicator pins protruding from the decorative material.

If the evaluation of the height of the visible part of an indicator pin reveals, for example, that it is too small, this is an indication that the decorative material does not bear against the carrier. In such a case, the decorative material can be positioned even better and laminated if the measured values of the height show the desired values.

In addition, the posture/position of the indicator pins is determined with the camera and the position at which the opening located above the opening in the carrier is to be introduced into the decorative material is determined therefrom.

The energy of the laser impinging on the decorative material is adjusted via the pulse frequency and the number of cycles such that only the decorative material and the adhesive are removed. For example, an ytterbium fiber laser of class 4 can be used as the laser, in particular with pulses of a maximum pulse energy of 1 mj, a pulse duration of 80 ns and a wavelength of 1064 nm.

As soon as a continuous opening, i.e. a hole, in the decorative material is produced by means of the laser and the laser beam has thus reached the opening in the carrier, the laser beam passes through this carrier opening and into a chamber located below the opening in the carrier, where the laser light is absorbed. This prevents the carrier and/or the decorative material from being damaged by scattered or reflected laser light. For this purpose, the chamber is preferably black or provided with a black coating or also lined with a black textile.

So that the decorative material can be laminated with its rear side onto the carrier, the rear side of the decorative material and/or the visible side of the carrier is preferably coated beforehand with a laminating material such as an adhesive, in particular a polyurethane hot-melt adhesive. It is particularly preferred to coat the rear side of the decorative material with a hot-melt adhesive which can be applied, for example, by means of a roller.

As soon as the decorative material with the hot-melt adhesive coating is correctly positioned on the rear side on the carrier material, the adhesive coating can be heated and thus the stickiness can be increased and the decorative material can be adhered onto the carrier.

The carrier is generally a molded part made of a thermoplastic plastic, aluminum, metal, a thermosetting resin, a natural fiber composite, carbon materials or other suitable materials.

The fixing device serves to fix the carrier and has at least two or more indicator pins which can be arranged in a line, but also in the form of a square, rectangle or otherwise on the visible side of the carrier. The further the openings in the carriers are located, the more indicator pins are required to obtain the desired precision of the openings.

Preferably, all indicator pins are located within the area spanned by the openings in the carrier. For example, if a plurality of slot-shaped openings spaced apart from one another in the form of a rectangle are arranged in the carrier, the indicator pin holes are located in the carrier (and the indicator pins in the fixing device), preferably the area spanned by the openings, i.e. within the rectangle, in particular centered, so that they are covered by a rectangular emblem which is fastened in the slots and are thus not visible.

The indicator pins are generally cylindrical. Their diameter is between 0.5 mm and 3.0 mm and preferably between 0.75 mm and 1.5 mm. Their length is preferably between 2.5 mm and 30 mm and particularly preferably between 10 mm and 20 mm, so that the indicator pins, their position and the length of the visible part of the indicator pin protruding from the decorative layer can be easily recognized and evaluated with the camera. Preferably, the height of the visible part of the indicator pins protruding over the decorative surface and being detected is between 1.0 mm and 10.0 mm, preferably between 2.5 mm and 7.5 mm and particularly preferably between 3.0 mm and 5.0 mm.

Generally, the indicator pins extend vertically upwards from the support surface of the fixing device on which the rear side of the carrier is arranged. Usually, the shape of the support surface corresponds to the shape of the rear side of the carrier. In addition, absorption chambers are provided in the support surface of the fixing device, each extending downwards where a carrier opening is located in an inserted carrier. The absorption chambers are preferably provided with a black coating absorbing the laser light, so that it is ensured that after complete penetration of the decorative material, the light entering the absorption chamber is almost completely absorbed. This prevents damage to the carrier or the decorative material by scattered or reflected laser light.

The openings in the carrier and the openings in the decorative material produced by the method according to the invention can be cylindrical, round, angular, oval, rectangular or otherwise shaped, but also have a non-cylindrical three-dimensional shape. The width and length of the openings can be selected as desired, preferably they are up to 2 mm and preferably up to 1.5 mm wide. The minimum width of the openings is at least 0.1 mm and preferably at least 0.5 mm. The length of the openings can vary greatly and depends on the desired application.

The method according to the invention is particularly suitable for slot-shaped, narrow openings in the decorative material, since these can be produced with high accuracy and quality by means of the laser and the method according to the invention.

The decorative material is preferably made of leather, artificial leather, polyvinyl chloride, thermoplastic elastomers, in particular based on olefins (TPO), polyurethanes (PUR) or another synthetic material or plastic or a woven fabric.

In general, the indicator pin holes in the decorative material are much smaller than the openings to be introduced into the decorative material later.

For the method according to the invention, decorative materials are preferably used in which the indicator pin holes are already introduced, preferably by means of a laser.

By means of the method according to the invention, a decorative material can be applied to two- or three-dimensional contours or surfaces and the openings corresponding to openings in the carrier material can be introduced into the decorative material by means of a laser.

The openings in the carrier and the decorative material serve for subsequent processes such as attaching emblems, logos, decorative elements or generally for joining together.

In addition, the openings in the carrier and in the decorative material can also serve for indirect illumination, wherein the openings can also have the shape of symbols or logos.

In the field of automotive interior fittings, such perforated surfaces are used on carriers, for example for driver airbag covers on the steering wheel, armrests, door interior fittings, instrument panels, etc.

An essential advantage of the method according to the invention is that the openings are introduced into the decorative material only when the decorative material is already laminated onto the carrier and the leather already has the desired three-dimensional shape. After the position of the openings to be introduced into the decorative material can be determined via the indicator pins, even small openings can be introduced into the decorative material with an exact fit and without contact by means of the laser, without damaging the carrier or the decorative material or other parts.

A further advantage of the method according to the invention is that it is contact-free and thus the disadvantages of the known mechanical method can be avoided. In addition, the sensitivity can be adjusted depending on the respective decorative material by means of the method according to the invention.

The invention as well as further advantageous embodiments and further developments thereof are described and explained in more detail below with reference to the examples shown in the drawings. The features to be taken from the description and the drawings can be applied according to the invention individually or in any combination. There are shown:

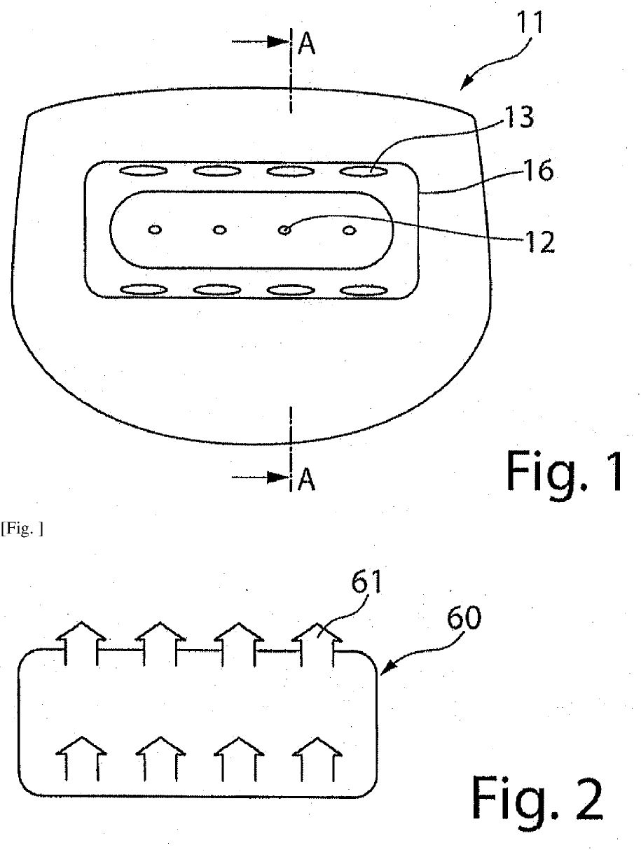

FIG. 1: a carrier with indicator pin holes and openings,

FIG. 2: an emblem for mounting on the carrier,

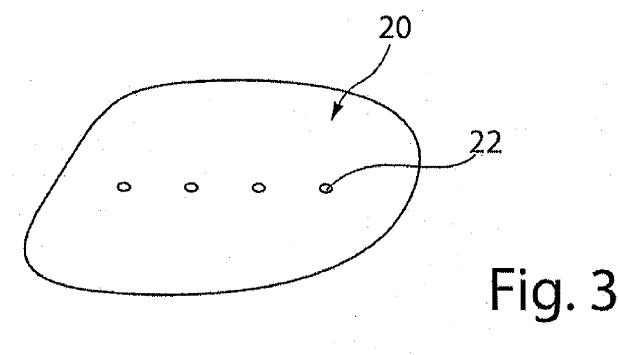

FIG. 3: a decorative cover with indicator pin holes,

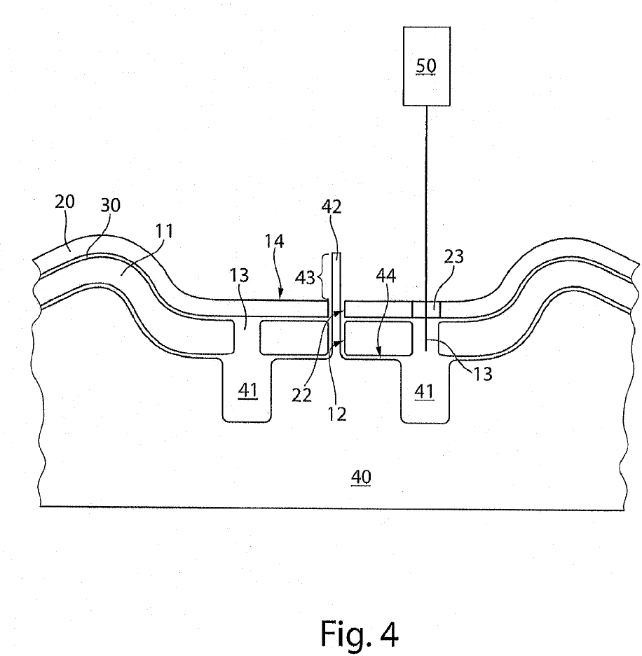

FIG. 4: a carrier with laminated decorative material in section along the line A-A in FIG. 1, which is fastened to the fixing device by means of an indicator pin before (left) and after (right) processing by means of a laser, and

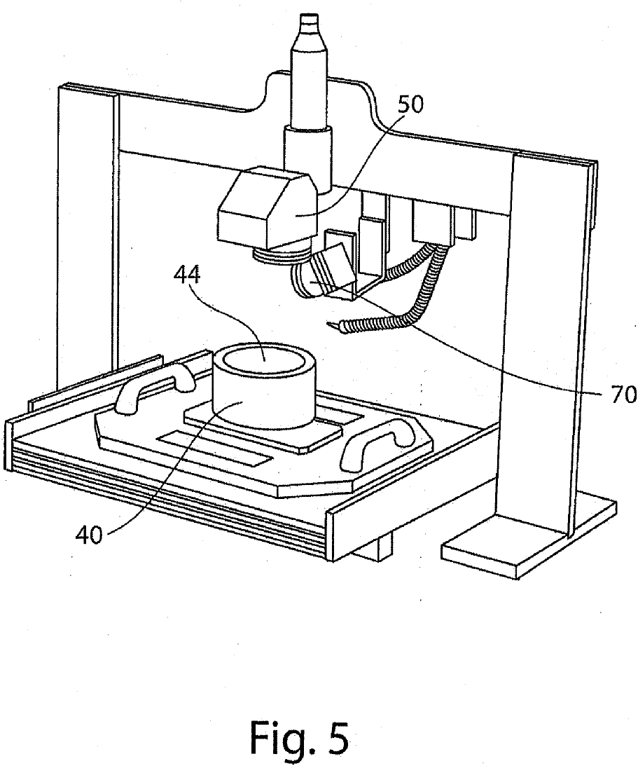

FIG. 5: a schematic representation of a system for carrying out the method according to the invention.

FIG. 1 shows a three-dimensionally shaped carrier 11 with a rounded rectangular recess 16 for receiving the emblem 60 shown in FIG. 2, which has a rounded rectangular shape corresponding to the recess 16. In the carrier 11 there are eight elongated openings 13 which run along the edge of the recess 16 and which serve for receiving the eight latching lugs 61 fastened to the emblem 60. Thus, the emblem 60 can be mounted on the carrier 11.

The carrier 11 in FIG. 1 furthermore has four indicator pin holes 12 which are arranged centrally in the recess 16 along a line. Through the indicator pin holes 12, the carrier 11 is clipped onto the indicator pins 42 of the fixing device 40 shown in FIG. 4 and through the indicator pin holes 22 in the decorative material 20 in FIG. 3, the decorative material 20 is clipped onto the indicator pins 42 and thus comes to rest on the carrier 11, cf. FIG. 4.

The position of the indicator pins 42 is detected by means of a camera 70 and the position of the openings 13 in the carrier 11 is calculated therefrom.

FIG. 4 shows the carrier 11 plugged onto the indicator pins 42 of the fixing device 40 and the decorative material 20 which is adhesively bonded to the carrier 11 on its underside by means of an adhesive layer 30.

Since the carrier 11 and the decorative material 20 are plugged onto the indicator pins 42 and the indicator pins 42 are longer than the total layer thickness of the carrier 11 and the decorative material 20 at the location of the indicator pins 42, only a visible part 43 of the indicator pin 42 protrudes upwards beyond the visible side 14 of the decorative material 20.

In order to determine whether the decorative material 20 is supported over the entire surface of the carrier 11, the length of the visible part 43 can be measured at each indicator pin 42. If the measured values are not the same at all indicator pins 42, the decorative material 20 is not uniformly supported on the carrier 11 at all indicator pins 42.

The left-hand side of FIG. 4 shows the decorative material 20 laminated onto the carrier 11, below which the opening 13 is located in the carrier 11 and below the absorption chamber 41. On the left-hand side, the decorative material 20 is still untreated.

On the right-hand side of FIG. 4, a laser 50 is schematically shown. The laser beam strikes the visible side 14 of the decorative material 20 and successively removes the decorative material 20 and the adhesive 30 until it then passes through the opening 13 in the carrier 11 and enters the absorption chamber 41. After the absorption chamber 41 is completely black lined, the entire laser radiation is absorbed there, so that it cannot be scattered back or reflected in the direction of the carrier 11 or decorative material 20.

The entire process is observed with a camera 70, which records the position of the indicator pins 42 and the height of the visible part 43 of the indicator pins 42. The position of the decorative material 20 and the positions of the opening 23 to be introduced into the decorative material 20 are determined from these values. In addition, the ablation process in the decorative material 20 for producing the opening 23 is monitored with the camera 70.

FIG. 5 shows a device for carrying out the method with a laser 50, a camera 70, a fixing device 40 which is shaped on its upwardly facing side, the support surface 44, corresponding to the shape of the underside of the carrier 11 and has a number of absorption chambers 41 (cf. FIG. 4) corresponding to the number of openings 13 in the carrier 11, which are located below the openings 13 of a carrier 11 placed in the fixing device 40. The indicator pins 42 extend vertically upwards from the support surface 44.

The laser 50, the fixing device 40 and the camera 70 are fixedly positioned relative to one another so that the laser 50 can be controlled and moved accordingly based on the position of the indicator pins 42 determined with the camera 70 and the height of the visible part 43 of the indicator pins 42 and thus introduces the openings 23 into the decorative material 20 at the desired location.

1. Method for introducing openings into a decorative material which is laminated onto a carrier with existing openings, comprising the following steps:
providing a fixing device with at least two indicator pins and at least one absorption chamber, providing a carrier with holes for receiving the indicator pins and the existing openings (13), and providing a decorative material with holes for receiving the indicator pins,
pushing the carrier onto the indicator pins of the fixing device and then pushing the decorative material onto the indicator pins of the fixing device, wherein the indicator pins extend through the holes in the carrier and the decorative material and visible parts of the indicator pins protrude above the decorative material, and
the decorative material is positioned on the carrier and laminated onto the carrier and new openings are introduced into the decorative material above the existing openings in the carrier by means of a laser,
wherein the positioning and lamination of the decorative material onto the carrier and the introduction of the new openings into the decorative material by means of the laser are effected by detecting the positions of the indicator pins and the heights of the visible parts of the indicator pins, and wherein the absorption chambers for absorbing the laser radiation are located below the existing openings in the carrier in the fixing device.

2. The method according to claim 1, characterized in that the detection of the position of the decorative material is effected by measuring the heights of the visible parts of the indicator pins by means of a camera.

3. The method according to claim 1, characterized in that the absorption chamber provided is black or provided with a black coating of a black textile.

4. The method according to claim 1, characterized in that a hot-melt adhesive is applied to the rear side of the decorative material before the lamination and the hot-melt adhesive is heated before the lamination.

5. The method according to claim 1, characterized in that a decorative material made of leather or artificial leather or polyvinyl chloride or thermoplastic elastomers, in particular based on olefins, or polyurethanes or another synthetic material or a woven fabric is provided as the decorative material.

6. The method according to claim 1, characterized in that the at least two indicator pins provided with the fixing device are cylindrical and have a diameter of between 10 mm and 20 mm.

7. The method according to claim 1, characterized in that the holes in the carrier are located within the area defined by the openings.

8. The method according to claim 1, characterized in that the openings in the carrier and the decorative material are larger than the holes.

9. Using the openings in the carrier and the decorative material according to the method of claim 1 for fastening emblems, logos, decorative elements or for backlighting.

10. The method according to claim 1, characterized in that the at least two indicator pins provided with the fixing device are cylindrical and have a diameter of between 2.5 mm and 30 mm.

11. The method according to claim 1, characterized in that the at least two indicator pins provided with the fixing device are cylindrical and have a diameter of between 0.75 mm and 1.5 mm.

12. The method according to claim 1, characterized in that the at least two indicator pins provided with the fixing device are cylindrical and have a diameter of between 0.5 mm and 1.5 mm.
